(19) United States
(12) Patent Application Publication
(10) Pub. No.: US 2026/0095746 A1
(43) Pub. Date: Apr. 2, 2026

(54) QUAD SIM/ESIM DUAL STANDBY WIRELESS DEVICE

(71) Applicant: Apple Inc., Cupertino, CA (US)

(72) Inventors: Jean-Marc PADOVA, San Francisco, CA (US); Abishek Kumar VAIDYANATHAN, Union City, CA (US); Kanuganti Rajeswar REDDY, Castro Valley, CA (US); Li LI, Los Altos, CA (US); Nithish Kulur PRABHAKARA, Sunnyvale, CA (US); Raj S. CHAUGULE, Santa Clara, CA (US); Vidur GUPTA, Atherton, CA (US); Viswanath NAGARAJAN, San Jose, CA (US)

(21) Appl. No.: 19/282,122

(22) Filed: Jul. 28, 2025

Related U.S. Application Data
(60) Provisional application No. 63/700,513, filed on Sep. 27, 2024.
(60) Provisional application No. 63/709,755, filed on Oct. 21, 2024.

(51) Int. Cl. H04W 8/18; H04W 8/30; H04W 76/30

(52) U.S. Cl. CPC H04W 8/183; H04W 8/30; H04W 76/30

(57) ABSTRACT

The described embodiments regard methods and apparatus for configuring a device that includes multiple subscriber identity modules (SIMs) and/or electronic SIMs (eSIMs) to support switching among active SIMs/eSIMs and standby SIMs/eSIMs via a software controlled hardware multiplexer. A wireless processor of a multi-SIM/eSIM wireless device includes a limited number of physical standardized interfaces, each interface supporting communication for a SIM/eSIM, and connects to multiple SIMs/eSIMs via a software controlled multiplexer. An applications processor of the multi-SIM/eSIM wireless device controls switching the interfaces between different SIMs/eSIMs. Software states of the SIMs/eSIMs are cached to allow rapid switching of SIMs/eSIMs between active and standby states. Interfaces of the SIMs/eSIMs continue to receive power in both the active and standby states, and interfaces are properly latched when switching to the standby state to allow rapid restoration when returning to the active state.

### CROSS-REFERENCE TO RELATED APPLICATIONS

The present application claims the benefit of U.S. Provisional Application No. 63/709,755, entitled “QUAD SIM/ESIM DUAL STANDBY WIRELESS DEVICE,” filed Oct. 21, 2024 and claims the benefit of U.S. Provisional Application No. 63/700,513, filed Sep. 27, 2024, of the same title, the contents of all of which are incorporated by reference herein in their entirety for all purposes.

### FIELD

The described embodiments relate to wireless communications, including methods and apparatus for configuring a device that includes multiple subscriber identity modules (SIMs) and/or electronic SIMs (eSIMs) to support switching among active SIMs/eSIMs and standby SIMs/eSIMs via a software controlled hardware multiplexer.

### BACKGROUND

Newer generation, fifth generation (5G), cellular wireless networks that implement one or more 3rd Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Typically, wireless devices have been configured to use removable UICCs, that include at least a microprocessor and a read-only memory (ROM), where the ROM is configured to store an MNO profile, also referred to as subscriber identity module (SIM) or SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs or integrated with other system components as iUICCs, which can provide advantages over traditional, removable UICCs. The eUICCs and/or iUICCs can include a rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. An eUICC/iUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

A multi-SIM/eSIM wireless device can include multiple SIMs and/or eSIMs that each are associated with a cellular wireless subscription. The multi-SIM/eSIM wireless device, due to hardware limitations, may be limited in the number of SIMs/eSIMs that can be used at any given time. A user can seek to configure the multi-SIM/eSIM wireless device can seek to allow for access to additional SIMs/eSIMs. There is a need to provide access to multiple cellular wireless subscriptions by a wireless device with limited hardware resources.

### SUMMARY

The described embodiments relate to wireless communications, including methods and apparatus for configuring a multi-SIM/eSIM wireless device to allow seamlessly switching between different combinations of physical subscriber identity modules (SIMs) and/or electronic SIMs (eSIMs). The multi-SIM/eSIM wireless device includes a wireless processor, e.g., a baseband component, with a limited number of standardized physical interfaces, e.g., ISO interfaces, where each active SIM/eSIM communicates via one of ISO interfaces. In an exemplary embodiment, the wireless processor supports two ISO interfaces, while the multi-SIM/eSIM wireless device supports more than two SIMs/eSIMs. In an exemplary embodiment, a software controlled physical multiplexer interfaces between the ISO interfaces of the baseband component and the corresponding interfaces of hardware that stores the SIMs/eSIMs, e.g., one or more physical SIM cards, also referred to as universal integrated circuit cards (UICCs), an eUICC storing one or more eSIMs, and/or a secure storage element that stores integrated SIMs. Interfaces to the hardware that stores the SIMs/eSIMs (or iSIMs) can be powered up and states of the interfaces can be latched when switching between different hardware for the baseband component to access. Software stacks associated with each SIM/eSIM can be maintained by the baseband component and cached as needed to allow for rapid switching of a SIM/eSIM between an active state in communication with the baseband component and a standby state where communication with the baseband component is suspended.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a mobile wireless device of the system of FIG. 1, according to some embodiments.

FIG. 3A illustrates a block diagram of an exemplary dual SIM wireless device in communication with two different wireless networks, according to some embodiments.

FIG. 3B illustrates block diagrams of exemplary multi-SIM and multi-SIM/eSIM wireless devices, according to some embodiments.

FIG. 4A illustrates a block diagram of exemplary elements of a multi-SIM/eSIM wireless device with a multiple standby SIM switching capability, according to some embodiments.

FIG. 4B illustrates a flow diagram of an example of reconfiguring modes of one or more SIMs and/or eSIMs of a multiple-SIM/eSIM wireless device, according to some embodiments.

FIG. 4C illustrates an exemplary mode transition diagram for an interface line for a SIM/eSIM between active and standby modes, according to some embodiments.

FIGS. 4D, 4E, and 4F illustrate block diagrams of an example of reconfiguring a communication interface via a multiplexer while changing modes for two SIMs of a multi-SIM/eSIM wireless device, according to some embodiments.

FIG. 5 illustrates a flow chart of an exemplary method to manage configuration of multiple SIMs and/or eSIMs of a multi-SIM/eSIM wireless device, according to some embodiments.

FIG. 6 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

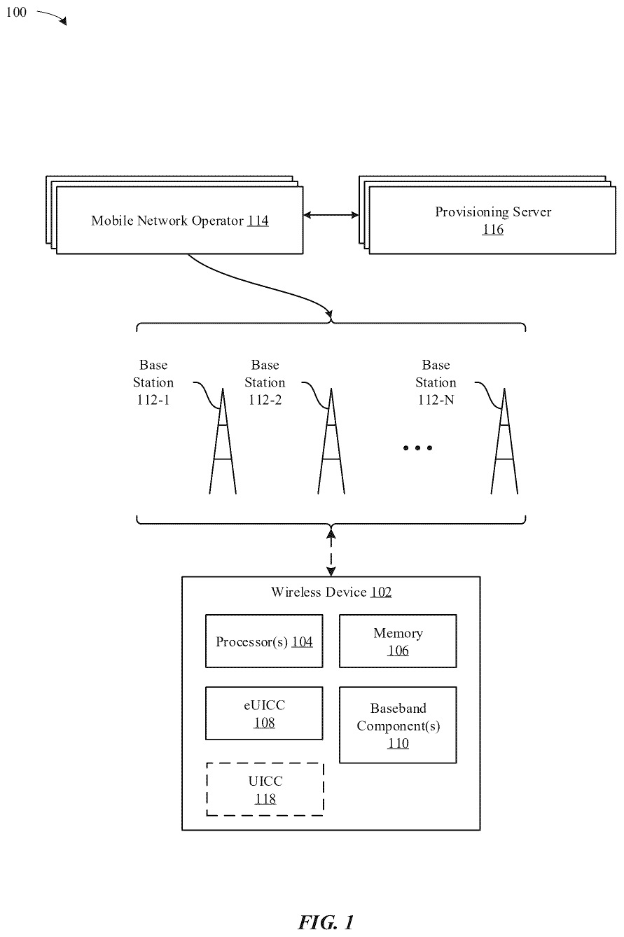

These and other embodiments are discussed below with reference to FIGS. 1 through 6; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUS)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. The baseband component 110 can also be referred to as a baseband processor. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIMs for accessing services offered by one or more different MNOs 114 via communication through base stations 112-1 to 112-N. To be able to access services provided by the MNOs, one or more eSIMs can be provisioned to the eUICC 108 of the wireless device 102. The wireless device 102 can include wireless circuitry, including the baseband component 110 and at least one transmitter/receiver, also referred to as a transceiver. In some embodiments, the wireless device 102 is configured to operate in a dual SIM/eSIM, single standby mode, with one SIM/eSIM enabled and one SIM/eSIM disabled (or partially enabled) where communication for the disabled (partially enabled) SIM/eSIM is transported at least in part by a cellular connection of the enabled SIM/eSIM. In some embodiments, the wireless device 102 includes two or more transceivers. In some embodiments, the wireless device 102 can be configured to operate in a dual SIM, dual standby (DSDS) mode, with two SIMs, one SIM and one eSIM, or two eSIMs enabled and active simultaneously, but allowing active connections to only one cellular wireless network via a single, active transceiver at a time. In some embodiments, the transceiver of the wireless device 102 includes multiple receivers to allow reception of signals from multiple wireless networks and only one transmitter for transmitting signals to one of the multiple wireless networks at a time. In some embodiments, the wireless device 102 includes hardware that is restricted to a dual SIM/eSIM dual standby capability and software and/or firmware that allows the wireless device 102 to emulate a quad SIM/eSIM dual standby (QSDS) capability, i.e., to provide a virtual QSDS capability by switching between SIMs/eSIMs between active states and standby states, where at most two SIMs/eSIMs can be in an active state at one time, and additional SIMs/eSIMs can be in a standby state, with interface lines to the SIMs/eSIMs in the standby state are powered and latched as needed, while software stacks are cached, to allow for a rapid return to use of the SIMs/eSIMs from the standby state to the active state.

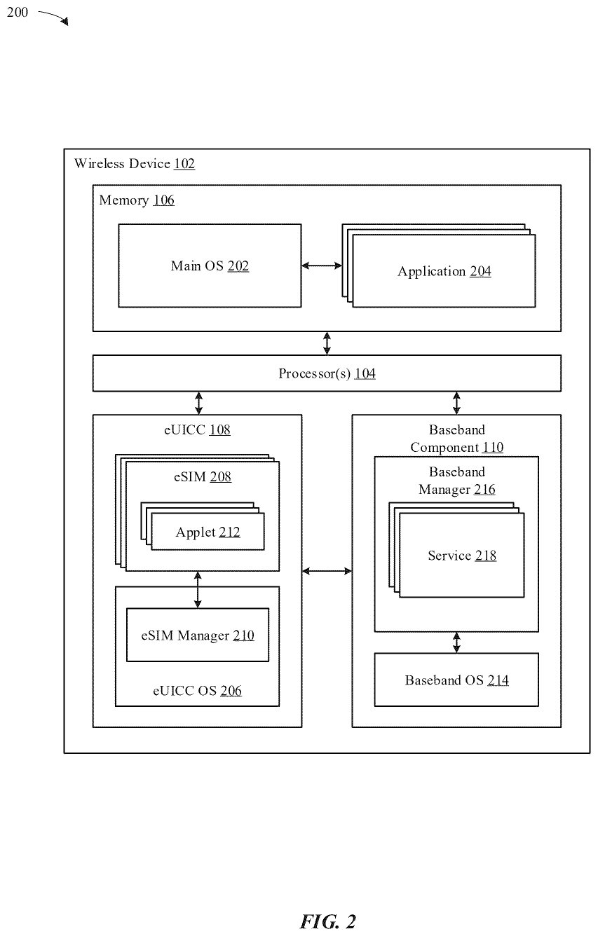

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM data) from the provisioning server 116 for purposes of managing eSIMs 208. The baseband manager 216 can be configured to implement services 218, which represent a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

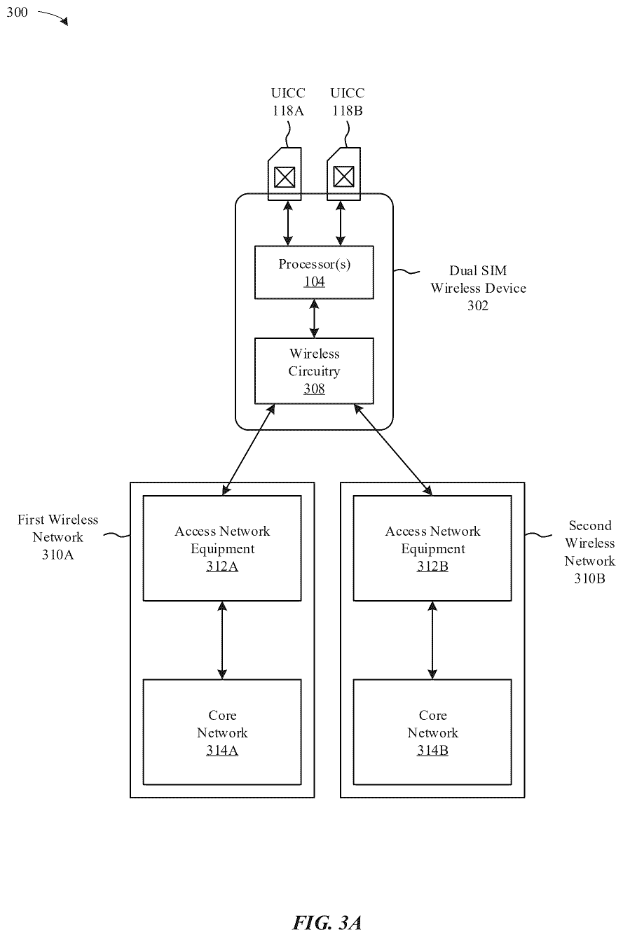

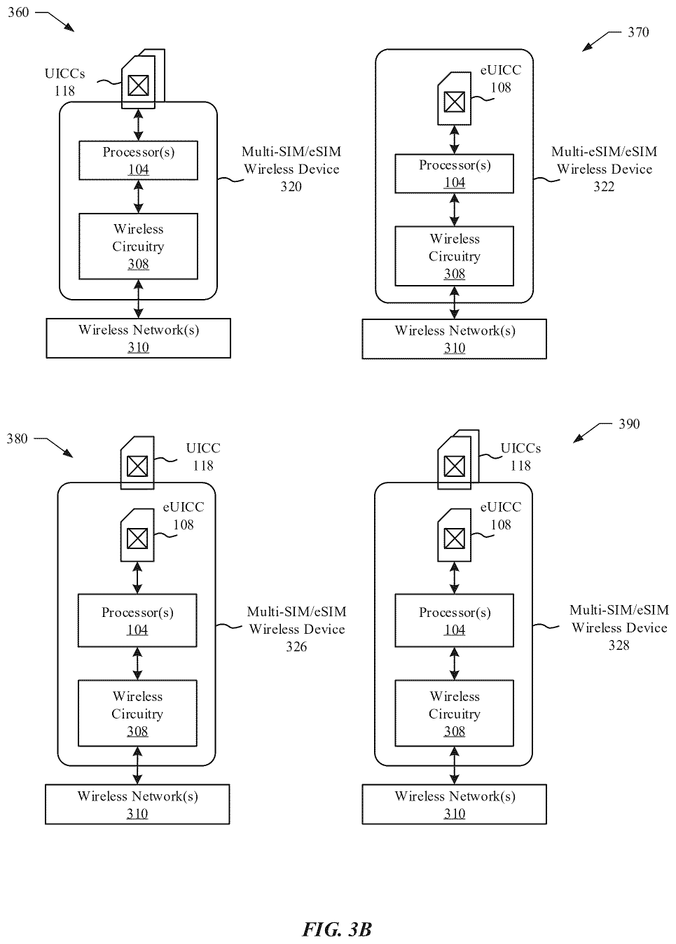

FIG. 3A illustrates a block diagram 300 of components of an exemplary dual SIM wireless device 302 including one or more processor(s) 104 and wireless circuitry 308 that provides for wireless radio frequency (RF) connections between the dual SIM wireless device 302 and a first wireless network 310A and a second wireless network 310B. In some embodiments, the wireless circuitry 308 can include the baseband component 110, and a set of RF analog front-end circuitry. In some embodiments, the wireless circuitry 308 and/or a portion thereof can include or be referred to as a wireless transmitter/receiver or a transceiver or a radio. The terms circuit, circuitry, component, and component block may be used interchangeably herein, in some embodiments, to refer to one or more operational units of a wireless device that process and/or operate on digital signals, analog signals, or digital data units used for wireless communication. For example, representative circuits can perform various functions that convert digital data units to transmitted radio frequency analog waveforms and/or convert received analog waveforms into digital data units including intermediate analog forms and intermediate digital forms. The wireless circuitry 308 can include components of RF analog front-end circuitry, e.g., a set of one or more antennas, which can be interconnected with additional supporting RF circuitry that can include filters and other analog components that can be “configured” for transmission and/or reception of analog signals via one or more corresponding antennas to one or more of the first and second wireless networks 310A/B. The processor(s) 104 and the wireless circuitry 308 can be configured to perform and/or control performance of one or more functionalities of the dual SIM wireless device 302, in accordance with various implementations. The processor(s) 104 and the wireless circuitry 308 can provide functionality for coordinating hardware/software resources in the dual SIM wireless device 302 to improve performance for mobility management of connections to one or more of the wireless networks 310A/B.

The dual SIM wireless device 302 includes two removable UICCs 118A/B, which can be inserted and removed from the dual SIM wireless device 302 together or independently. Each UICC 118A/B includes at least one software identity module (SIM), which can be embodied as a software/firmware program installed on the UICC 118A/B. Removable UICCs 118A/B can provide a user of the dual SIM wireless device 302 the ability to replace a UICC to change services, provided the dual SIM wireless device 302 supports such flexibility (e.g., an “unlocked” device that is not “locked” to a particular wireless network operator or service provider). Hardware complexity and/or a size of a wireless device can limit the ability to include multiple UICC slots, and thus additional arrangements for wireless devices can include multiple SIMs on a single UICC 118 and/or eSIMs 208 on an eUICC 108 or combinations thereof. The dual SIM wireless device 302, in some embodiments, can register with two different wireless networks, e.g., the first and second wireless networks 310A/B, simultaneously. The first wireless network 310A can operate in accordance with a first wireless communication protocol, e.g., a 5G NR wireless communication protocol, while the second wireless network 310B can operate with a second wireless communication protocol that can be the same as the first wireless communication protocol or a different wireless communication protocol, e.g., a 4G LTE wireless communication protocol. The first and second wireless networks 310A/B can operate using different radio frequency bands in accordance with their respective wireless communication protocols. The first and second wireless network 310A/B can operate using different radio frequency bands of a common wireless communication protocol, e.g., using an FR1 RF band and an FR2 band of a 5G NR wireless communication protocol. The wireless circuitry 308 of the dual SIM wireless device 302 can be configured to register with and/or establish a connection with the first wireless network 310A via access network equipment 312A, which interfaces with a core network 314A. The wireless circuitry 308 of the dual SIM wireless device 302 can also be configured to register with and/or establish a connection with the second wireless network 310B via access network equipment 312B, which interfaces with a core network 314B. In some embodiments, the wireless circuitry 308 of the dual SIM wireless device 302 supports transmission and reception to only one of the first and second wireless networks 310A/B at a time. In some embodiments, the wireless circuitry 308 of the dual SIM wireless device 302 supports transmission to only one of the first and second wireless networks 310A/B at a time and reception from one or both of the first and second wireless networks 310A/B. A dual SIM wireless device 302 that can connect to only one wireless network at a time, but can monitor and/or receive communication from two wireless networks with which it is registered, can be referred to as a “Dual SIM, Dual Standby” (DSDS) wireless device. A dual SIM wireless device 302 that can connect to two wireless networks simultaneously using two different subscriber identities can be referred to as a “Dual SIM, Dual Active” (DSDA) wireless device.

FIG. 3B illustrates diagrams 360, 370, 380, 390 of additional exemplary multi-SIM/eSIM wireless devices 320, 322, 326, 328 that support multiple subscriptions using removable UICCs 118 and/or eUICCs 108 with SIMs or eSIMs 208 implemented respectively thereon. As illustrated in diagram 360, a multi-SIM/eSIM wireless device 320 includes multiple UICCs 118, which can be inserted and removed individually or together, and communicate with one or more processors 104 that connect to wireless circuitry 308 that provides for wireless communication with one or more wireless networks 310. As the physical size and design of the multi-SIM/eSIM wireless device 320 can limit the number of UICCs 118 that can be supported, alternatively as shown by diagram 370, a multi-SIM/eSIM wireless device 322 can include an eUICC 108 connected with the processor(s) 104 and to the wireless network(s) 310 via the wireless circuitry 308. The eUICC 108 can be built into the multi-SIM/eSIM wireless device 322 and can be not removable from the multi-SIM/eSIM wireless device 322, e.g., permanently affixed to a circuit board in the multi-SIM/eSIM wireless device 322. The eUICC 108 can be programmed such that one or more eSIMs 208 can be implemented on the eUICC 108. Each eSIM 208 can be associated with a distinct subscriber identity and/or provide distinct services or subscriptions for a user of the multi-SIM/eSIM wireless device 322. Diagram 380 illustrates a multi-eSIM/SIM wireless device 326 that includes a removable UICC 118, on which can be installed one or more SIMs, and an eUICC 108 on which one or more eSIMs 208 can be installed. The combination of SIMs on the UICC 118 and/or eSIMs 208 on the eUICC 108 can provide for connections to one or more wireless networks 310 using the wireless circuitry 308 under the control of the processor(s) 104 of the multi-SIM/eSIM wireless device 326. Diagram 390 illustrates another multi-eSIM/SIM wireless device 328 that includes multiple UICCs 118, on which one or more SIMs can be installed, and an eUICC 108, on which one or more eSIMs 208 can be installed. A combination of one or more SIMs on a UICC 118 and/or eSIMs on an eUICC 108 can provide for connections to one or more wireless networks 310 using the wireless circuitry 308 under the control of the processor(s) 104 of the multi-SIM/eSIM wireless device 328. In general, a wireless device 102 that supports multiple subscriber identities can include (i) at an eUICC 108 and/or (ii) one or more UICCs 118. Each UICC 118 can support one or more SIMs, and each eUICC 108 can support one or more eSIMs 208. A wireless device 102 that supports multiple subscriber identities, e.g., 302, 320, 322, 326, 328, can include a combination of SIMs and/or eSIMs 208 to support communication with one or more wireless networks 310.

In some regions, some multi-SIM/eSIM wireless devices 320 are configured to support multiple UICCs 118 via a multiple SIM tray, typically dual UICCs 118 via a dual SIM tray, e.g., a dual SIM wireless device 302 as shown in FIG. 3A. In a typical configuration each UICC 118A/B is connected via an individual physical standardized interface, e.g., an ISO interface, to a processor 104, which can be a baseband component 110 with a limited number of individual ISO interfaces. To add the flexibility of access to additional cellular wireless services via eSIMs 208 stored on an eUICC 108 while retaining the dual SIM tray with dual UICCs 118 would require complex and costly changes to the baseband hardware, such as by requiring addition of a third ISO line for the eUICC 108 in addition to the two ISO lines used for communication with the two UICCs 118A/B in the dual SIM tray. Similarly adding ISO lines can require use of valuable general purpose input output (GPIO) ports and system on a chip (SoC) space. To overcome these physical limitations, as proposed herein, a software controlled physical multiplexer can be interposed between the baseband component 110 and physical hardware that stores the SIMs/eSIMs to allow for switching seamlessly between use of different SIMs/eSIMs without requiring addition of another ISO line to the baseband component 110. Generally, the multi-eSIM/eSIM wireless device can include a baseband component 110 that includes N ISO lines connected via a software controlled hardware multiplexer to secure elements that stores SIMs/eSIMs, where up to N of the SIMs/eSIMs can be simultaneously active and the remaining SIMs/eSIMs can be in a standby state, where switching between SIMs/eSIMs can be rapid and not require powering up or significant delays. In some embodiments, i) hardware interfaces to the secure elements can remain powered with states latched and ii) software states (e.g., baseband software stacks) for SIMs/eSIMs can be cached to allow for seamlessly switching SIMs/eSIMs between an active state and a standby state.

A multiple-SIM/eSIM capability can be realized for any combination of SIMs/eSIMs (up to a number of simultaneous independent ISO lines supported by the baseband component 110). This flexible reconfiguring of access to SIMs/eSIMs can allow the multi-SIM/eSIM wireless device to be reconfigured based on network coverage, subscription costs, etc., and can offer to a user of the multi-SIM/eSIM wireless device options for selection of which SIMs/eSIMs to be active and use for cellular wireless access from a pool of SIMs/eSIMs available in the multi-SIM/eSIM wireless device. SIMs/eSIMs that are not active can remain in a standby mode. Switching of the ISO ports of the baseband component 110 between different interfaces of the SIMs/eSIMs can be controlled by an module of an applications processor, e.g., a telephony module and/or a communications center module, directly to a software controlled multiplexer or via the baseband component 110. In some embodiments, enabled applications can perform a status check to determine that a SIM/eSIM is in a proper state before switching between active mode and a standby mode. In some embodiments, polling of the SIM/eSIM can be performed when entering an active mode to ensure the SIM/eSIM is in a proper and/or expected state.

In some embodiments, a SIM/eSIM interface includes a voltage line Vcc, a clock line, a data line, and a reset line. In the active state, power is provided via the voltage line Vcc, while the clock, data, and reset lines are attached to a particular ISO port of the baseband component 110. When changing to a standby state for a SIM/eSIM, the corresponding SIM/eSIM interface is configured by continuing to provide power via the voltage line Vcc, while the clock, data, and reset lines are detached from the particular ISO port of the baseband component. 110. In some embodiments, the SIM/eSIM interface line is configured as follows: the power voltage line Vcc is maintained, the clock line is halted (in a clock-stop mode), the data line is latched in a high state (in a reception mode), and the reset line is latched in a high state. In addition, when changing to the standby state, the SIM/eSIM software state (which can include various parameters for a software stack) are cached in the baseband component 110. In some embodiments, software state information for the SIM/eSIM is further cached in the applications processor. When returning the SIM/eSIM from the standby state to the active state, power continues to be provided via the voltage line Vcc, while the clock, data, and reset lines are re-attached to a particular ISO port of the baseband component 110, and the software state of the SIM/eSIM is restored from cache in the baseband component 110.

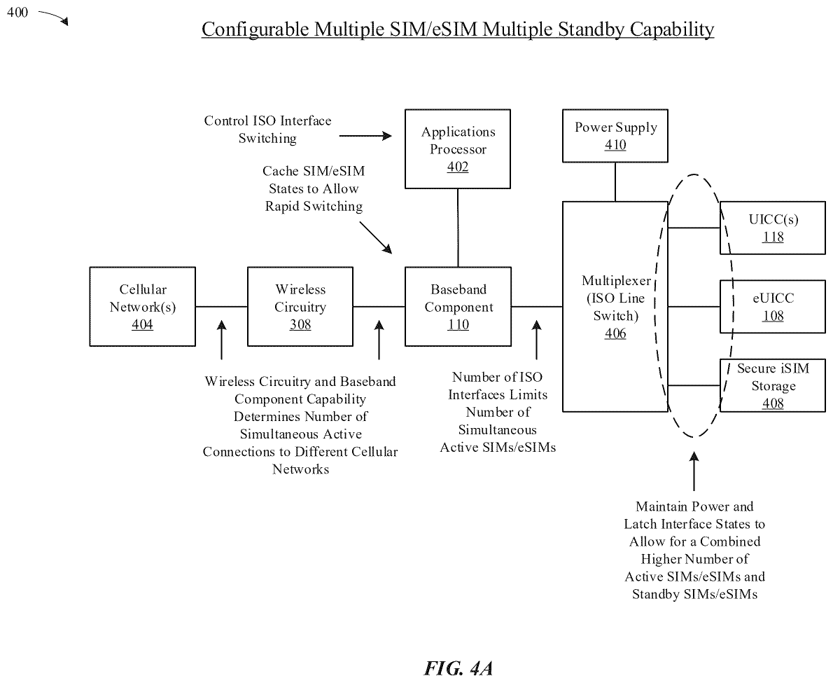

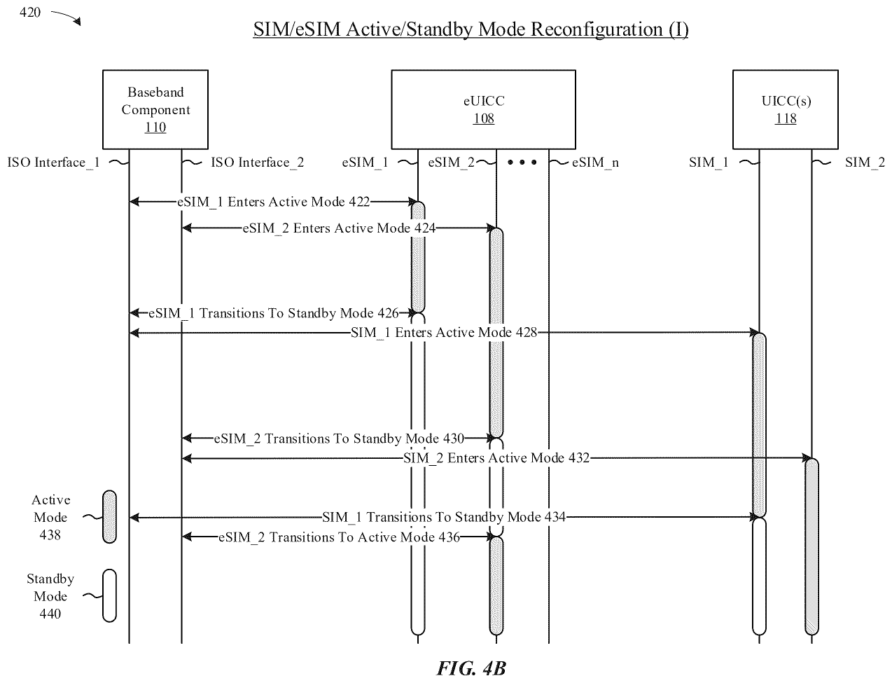

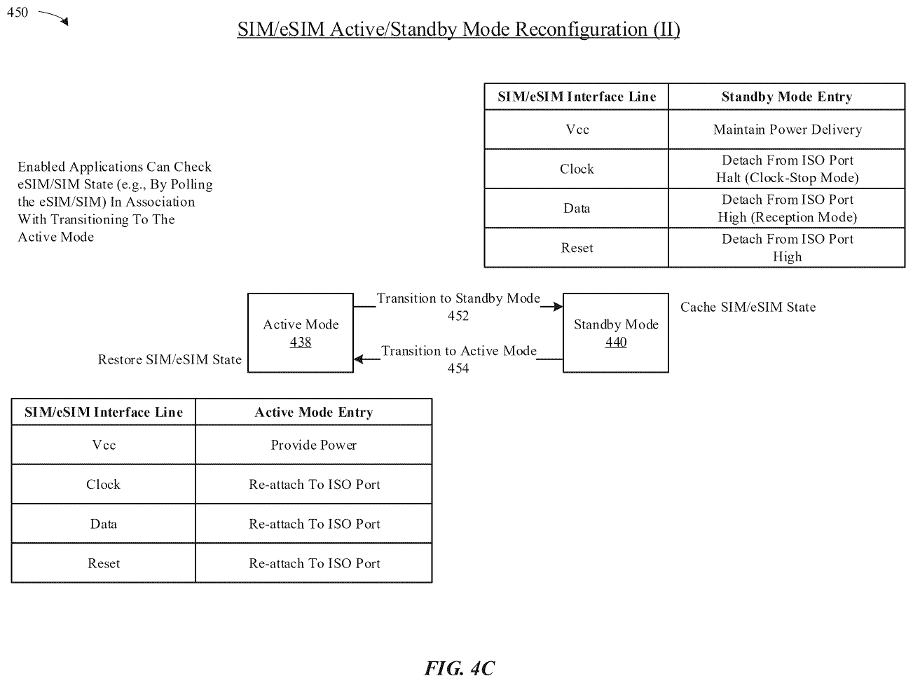

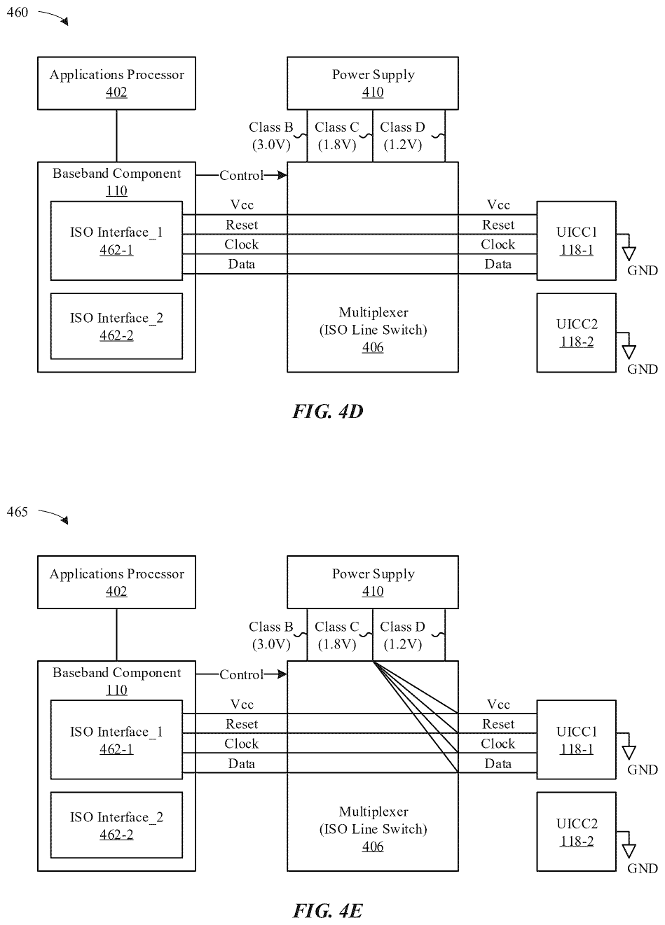

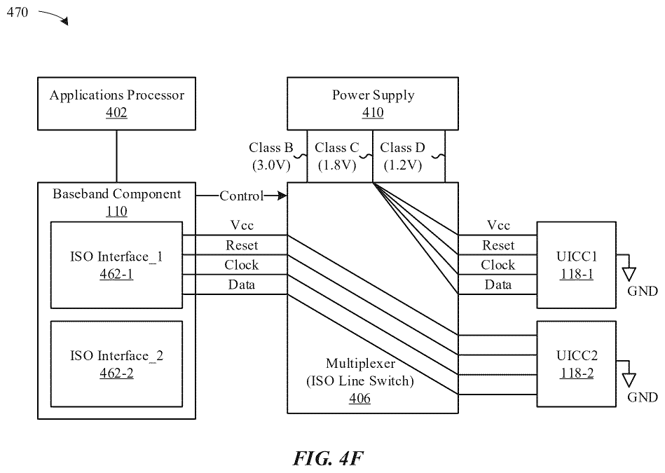

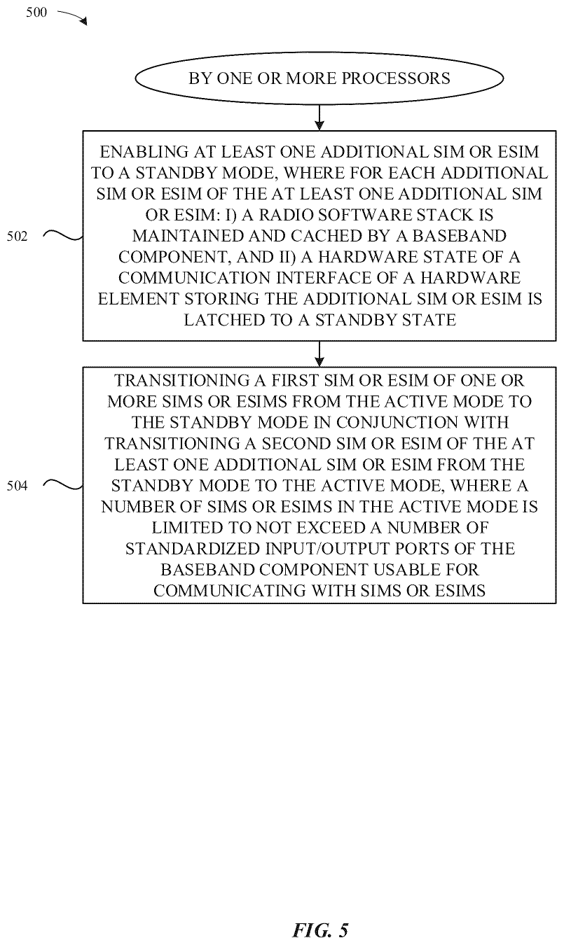

FIG. 4A illustrates a block diagram 400 of exemplary elements of a multi-SIM/eSIM wireless device configurable to switch use of SIMs/eSIMs between active and standby states. The multi-SIM/eSIM wireless device includes wireless circuitry 308 and a baseband component 110 that determines a capability of the multi-SIM/eSIM wireless device to communicate with one or simultaneous active connections to different cellular networks 404. In some embodiments, the multi-SIM/eSIM wireless device supports multiple active connections, e.g., for a dual-SIM dual-active (DSDA) device. In some embodiments, the multi-SIM/eSIM wireless device supports at most one active connection and multiple standby connections, e.g., for a dual-SIM dual standby (DSDS) device. In general, a multi-SIM/eSIM wireless device can include a number of SIMs/eSIMs that exceed a number of active connections that can be maintained simultaneously by the multi-SIM/eSIM wireless device. The baseband component 110 can communicate with SIMs/eSIMs via standardized physical interfaces, e.g., via one or more ISO interfaces. The number of ISO interfaces of the baseband component 110 can limit the number of SIMs/eSIMs that can be in an active state simultaneously. Note that a SIM/eSIM in an active state does not necessarily imply that SIM/eSIM has an active connection with a cellular wireless network 404, but rather that connections can be established by and/or for the active SIM/eSIM. For each SIM/eSIM the baseband component 110 can maintain a radio software stack. An applications processor 402 connects to the baseband component 110 and can include a telephony module and/or a communications center module to manage cellular connections for the multi-SIM/eSIM wireless device. The multi-SIM/eSIM wireless device can further include multiple SIMs and/or eSIMs, which can be realized as physical SIMs stored in UICCs 118, as eSIMs stored in an eUICC 108, and/or as iSIMs stored in a secure iSIM storage element 408. The hardware elements that store the SIMs/eSIMs can be connected to the baseband component 110 indirectly through a software controlled physical multiplexer (ISO line switch) 406. The software controlled physical multiplexer can permit the number of interfaces for the SIMs/eSIMs to exceed the number of ISO interfaces into the baseband component 110. Each enabled SIM/eSIM of the multi-SIM/eSIM wireless device can be configured to be in an active mode or in a standby mode. SIMs/eSIMs can also be in a disabled state and unavailable for communication until put into the enabled state. The applications processor 402 can control switching of the ISO interfaces of the baseband component 110 between different SIMs/eSIMs. A power supply 410 can provide one or more voltages that correspond to those required by the hardware elements that store the SIMs/eSIMs. The software controlled physical multiplexer 406 can maintain power to the various SIM/eSIM hardware elements and can switch the interface lines of the SIM/eSIM hardware elements to applicable ISO interface ports of the baseband component 110 when switching between different SIMs/eSIMs to be in the active mode and remaining SIMs/eSIMs to be in the standby mode.

FIG. 4B illustrates a flow diagram 420 of an example of reconfiguring modes of one or more SIMs and one or more eSIMs 208 of a multi-SIM/eSIM wireless device. A baseband component 110 of the multi-SIM/eSIM wireless device includes two distinct communication interfaces, which can be ISO interfaces, labeled as ISO Interface_1 and ISO Interface_2 respectively. While the baseband component 110 illustrated includes two ISO communication interfaces, in general, a baseband component 110 can have any non-zero number of communication interfaces, which may operate in accordance with a communication interface standard. The multi-SIM/eSIM wireless device can include a hardware communication interface multiplexer that can switch the communication interfaces of the baseband component 110 among one or more UICCs 118 that each include a corresponding SIM and/or an eUICC 108 that can include one or more eSIMs 208. In the example illustrated in FIG. 4B, the first communication interface (ISO Interface_1) is connected, via the communication interface of the eUICC 108, to a first eSIM (eSIM_1) 208, which transitions, at 422, to an active mode 438 while in an enabled state. In some embodiments, the first eSIM 208 changes from a disabled state to the enabled state in conjunction with entering the active mode 438 at 422. In some embodiments, the first eSIM 208 is in an enabled state and changes from a standby mode 440 to the active mode 438 at 422. At 424, the second communication interface (ISO Interface_2) of the baseband component 110 is connected, via the communication interface of the eUICC 108, to a second eSIM (eSIM_2) 208, which transitions to an active mode while in the enabled state. In some embodiments, the second eSIM 208 changes from a disabled state to the enabled state in conjunction with entering the active mode 438 at 424. In some embodiments, the second eSIM 208 is in an enabled state and changes from a standby mode 440 to the active mode 438 at 422.

As the baseband component 110 includes only two ISO interfaces, in order to provide access to wireless communication services of a different SIM/eSIM from any two SIMs/eSIMs in use at a given time, the applications processor 402 of the multi-SIM/eSIM wireless device can instruct the baseband component 110 and a hardware ISO line switching multiplexer 406 to reconfigure the ISO interfaces of the baseband component 110 between different SIMs/eSIMs. An existing SIM/eSIM can be transitioned from the active mode 438 to the standby mode 440 before reconfiguring to connect to a different SIM/eSIM. For the reconfiguration example illustrated in FIG. 4B, at 426, the baseband component 110 transitions the first eSIM 208, which is connected to the first ISO interface, from the active mode 438 to the standby mode 440. Subsequently, at 428, first ISO interface of the baseband component 110 is connected to a communication interface of a first UICC 118 that includes a first SIM (SIM_1), and the first SIM enters the active mode 438 while an enabled state. In some embodiments, the first SIM changes from a disabled state to the enabled state in conjunction with entering the active mode 438 at 428. In some embodiments, the first SIM is in an enabled state and changes from a standby mode 440 to the active mode 438 at 428.

Continuing at 430, the applications processor 402 of the multi-SIM/eSIM wireless device can instruct the baseband component 110 and the hardware ISO line switching multiplexer 406 to reconfigure the second ISO interface from use of the second eSIM (eSIM_2) 208 to a second SIM (SIM_2) on a second UICC 118 included in the multi-SIM/eSIM wireless device. At 430, the baseband component 110 transitions the enabled second eSIM 208, which is connected to the second ISO interface, from the active mode 438 to the standby mode 440. Subsequently, at 432, the second ISO interface of the baseband component 110 is connected to a communication interface of the second UICC 118 that includes the second SIM, and the second SIM enters the active mode 438 while in an enabled state. In some embodiments, the second SIM changes from a disabled state to the enabled state in conjunction with entering the active mode 438 at 432. In some embodiments, the second SIM is in an enabled state and changes from a standby mode 440 to the active mode 438 at 432.

Continuing at 434, the applications processor 402 of the multi-SIM/eSIM wireless device can instruct the baseband component 110 and the hardware ISO line switching multiplexer 406 to reconfigure the first ISO interface from use of the first SIM (SIM_1) to the second eSIM 208 via the communication interface of the eUICC 108. Initially, at 434, the baseband component 110 transitions the enabled first SIM (SIM_1) from the active mode 438 to the standby mode 440. Subsequently, at 436, the first ISO interface of the baseband component is connected to the communication interface of the eUICC 108, and the second eSIM (eSIM_2) 208 transitions from the standby mode 440 to the active mode 438.

The reconfiguration actions illustrated by the diagram 420 in FIG. 4B can be applied to any combination of eSIMs 208 stored in an eUICC 108 and/or SIMs stored in respective UICCs 118. The number of SIMs/eSIMs that can be simultaneously in an active mode can be limited to not exceed the number of ISO interfaces available to interface with the eUICC 108 and/or UICCs 118. When reconfiguring the state of a SIM or eSIM 208 from the active mode to the standby mode state of software stacks used for managing the communication via the SIM or eSIM 208 can be cached and later retrieved to restore the previous state when reconfiguring the SIM or eSIM 208 from the standby mode to the active mode. In addition, the communication interface of the hardware element storing the SIM or eSIM 208, e.g., a corresponding UICC 118 or the eUICC 108, can be latched to a standby state, where power continues to be supplied to the hardware element and additional lines, such as data, clock, and reset lines, are held to a voltage value that suspends use of the SIM or eSIM 208. The communication interface of the hardware element in the standby state can be disconnected from the ISO interface of the baseband component 110 and continued to be held in the standby state. Subsequently, when reconfiguring the SIM or eSIM 208 from the standby mode to the active mode, the communicating interface can be reconnected to the ISO interface of the baseband component 110 and then subsequently released from the standby state to allow communication to restart between the baseband component 110 and the SIM or eSIM 208 stored by the hardware element. Reconfiguration of connections of the baseband component 110 ISO interfaces and of the communication interfaces of the hardware elements storing the SIMS and/or eSIMs 208 can be effected via an ISO line switching multiplexer 406, which can be controlled via one or more processors of the multi-SIM/eSIM wireless device, e.g., via an applications processor 402 directly or indirectly via the baseband component 110.

FIG. 4C illustrates an exemplary mode transition diagram 450 for a SIM or eSIM 208 between the active mode 438 and the standby mode 440. When the SIM or eSIM 208 is in the active mode 438, power is being provided and the clock, data, and reset lines of a communication interface for the hardware element storing the SIM or eSIM 208, e.g., a UICC 118 or an eUICC 108, is connected to the communication interface port, e.g., ISO port, of the baseband component 110 via an ISO line switching multiplexer 406. When the SIM or eSIM 208 undergoes the transition 452 to the standby mode 440 from the active mode 438, the communication interface of the hardware element storing the SIM or eSIM 208 is connected via an ISO line switching multiplexer 406 to an applicable control signals to cause the communication interface to be placed in a standby state. In some embodiments, the applicable control signals are an applicable voltage supply line that holds various lines of the communication interface in a high voltage value state, where the various lines can include a clock line, a data line, and a reset line. In some embodiments, the applicable control signals hold the clock line to a halt state to put the clock line in a clock-stop mode. In some embodiments, the applicable control signals hold the data line to high state to put the data line into a reception mode. In some embodiments, the applicable control signals hold the reset line to a high state. In addition to managing the hardware state for the SIM or eSIM 208, one or more processors of the multi-SIM/eSIM wireless device can cache a state of a baseband software stack (and/or other applicable software information) for the SIM or eSIM 208 to allow for restoring the SIM or eSIM 208 later to an active mode. A supply voltage, Vcc, for the hardware element storing the SIM or eSIM also maintains power delivery to the hardware element while in the SIM or eSIM 208 is in the standby mode. The communication interface of the hardware element storing the SIM/eSIM is then detached from the communication interface, e.g., the ISO port, of the baseband component 110. The SIM or eSIM 208 can continue to be in the enabled state while in the standby mode, and in some embodiments, an indication that the SIM or eSIM 208 is available for use can be indicated via an interface of the multi-SIM/eSIM wireless device. By continuing to power the hardware element storing the SIM or eSIM 208, holding the communication interface to a standby state, and caching software information used for baseband communication, the SIM or eSIM 208 can be restored to an active mode quickly without requiring a lengthy restoration process.

When the SIM or eSIM 208 undergoes the transition 454 from the standby mode 440 to the active mode 438, the communication interface of the hardware element storing the SIM or eSIM 208 can be re-attached to a communication interface, e.g., an ISO port, of the baseband component 110. The previously cached software state for the SIM or eSIM 208 can be retrieved and restored for baseband software stacks (and/or other applicable communication software processes). After re-attachment to the communication interface, e.g., the ISO port, of the baseband component 110, the communication interface of the hardware element storing the SIM or eSIM 208 can be disconnected from the control signals that are holding the SIM/eSIM interface in the standby state. In some embodiments, the clock line, data line, and reset line are detached from the control signals to allow the baseband component 110 to communicate via the ISO port to the SIM or eSIM 208. The voltage supply line, Vcc, continues to provide power in the active mode and does not change connection whether in the active mode or standby mode. In some embodiments, connecting and disconnecting lines of the communication interfaces can be effected via an ISO port line switching multiplexer 406.

FIGS. 4E, 4E, and 4F illustrate block diagrams 460, 465, 470 of an exemplary transition of a communication interface, e.g., an ISO port, of a baseband component 110 from a first hardware element, e.g., a first UICC (UICC1) 118-1, to a second hardware element, e.g., a second UICC (UICC2) 118-2, where a SIM stored in the first UICC 118-1 transitions from an active mode to a standby mode while in the enabled state, and a SIM stored in the second UICC 118-2 is connected to the ISO port. As shown in block diagram 460 of FIG. 4D, applicable lines of a first communication interface, e.g., ISO Interface_1 462-1, of a baseband component 110 are connected to corresponding lines of a communication interface of UICC1 118-1 via an ISO line switching multiplexer 406. An applications processor 402 communicates with the baseband component 110 and one or more both of the applications processor 402 and the baseband component 110 can control the ISO line switching multiplexer 406 to change connections for the communication interface(s) of the baseband component 110, UICC1 118-1, and UICC2 118-2. In some embodiments, the applicable lines of the communication interfaces include a Vcc line, a reset line, a clock line, and a data line. The applications processor 402 and/or the baseband component 110 can control the ISO line switching multiplexer 406 to transition the SIM of UICC1 118-1 from the active mode to the standby mode in conjunction with connecting a SIM of UICC2 118-2 to the same communication interface, e.g., ISO Interface_1 462-1, of the baseband component 110 to allow the SIM of UICC2 118-2 to use the communication interface in place of the SIM of UICC1 118-1. As shown in diagram 465 of FIG. 4E, an applicable power supply voltage of the power supply 410 for the UICC1 118-1, e.g., Class C 1.8V power, can be connected to the lines of the communication interface of UICC1 118-1 in parallel with the existing connection to the ISO Interface_1 462-1 of the baseband component. This power supply voltage can maintain power to the UICC1 118-1 while holding the reset line to a high voltage state, the data line to a high reception mode state, and the clock line to a halt clock-stop mode state. Communication state information for a baseband software stack maintained by the baseband component 110 for the SIM of UICC1 118-1 (and other applicable communication state information managed by the baseband component 110 and/or the applications processor 402 for communication via the SIM of UICC1 118-1) can be cached. Subsequently, as shown in diagram 470 of FIG. 4F, the lines of the communication interface of UICC1 118-1 can be disconnected from the ISO Interface_1 462-1 of the baseband component 110. The lines of the communication interface of UICC2 118-2 can be connected instead to the ISO interface_1 462-1 of the baseband component 110 to allow a SIM of UICC2 118-2 to be used for wireless communication by the baseband component 110.

While not shown in FIGS. 4D and 4E, the communication interface of UICC2 118-2 can be held in a standby state by connection to an applicable power supply voltage of the power supply 410, so that both the SIM of UICC1 and the SIM of UICC2 can be in a standby state prior to disconnecting the communication interface of UICC1 from the ISO Interface_1 462-1 of the baseband component 110. Subsequently, the communication interface of UICC2 118-2 can be connected to the ISO Interface_1 462-1 of the baseband component 110 in parallel with connection to the applicable voltage of the power supply 410, and then the connections of the lines of the communication interface of UICC2 118-2 can be disconnected from the power supply 410 voltage to allow communication between the baseband component 110 via the ISO Interface_1 462-1 with the SIM of UICC2 118-2 in the active mode. The baseband component 110 illustrated in FIGS. 4D, 4E, and 4F includes a second communication interface, ISO Interface_2 462-2, which could have be used to connect to UICC2 118-2 or can be used to connect to another hardware element storing a SIM or eSIM 208, e.g., to an eUICC 108 or to another UICC 118.

FIG. 5 illustrates a flow chart 500 of a representative method to manage configuration of multiple SIMs and/or eSIMs 208 of a multi-SIM/eSIM wireless device. At 502, the method includes enabling at least one additional SIM or eSIM 208 to a standby mode 440, where for each additional SIM or eSIM 208 of the at least one additional SIM or eSIM 208, i) a radio software stack is maintained and cached by a baseband component 110, and ii) a hardware state of a communication interface of a hardware element storing the additional SIM or eSIM 208 is latched to a standby state. At 504, the method further includes transitioning a first SIM or eSIM 208 of one or more SIMs or eSIMs 208 from an active mode 438 to the standby mode 440 in conjunction with transitioning a second SIM or eSIM 208 of the at least one additional SIM or eSIM 208 from the standby mode 440 to the active mode 438, where a number of SIMs or eSIMs 208 in the active mode 438 is limited to not exceed a number of standardized input/output ports of the baseband component 110 usable for communicating with SIMs or eSIMs 208.

In some embodiments, the standardized input/output ports of the baseband component 110 are communicatively coupled to corresponding communication interfaces of one or more hardware elements storing the one or more SIMs or eSIMs 208 and/or to the hardware element storing the additional SIM or eSIM 208 via a hardware ISO line switching multiplexer 406. In some embodiments, at least one of the one or more SIMs or eSIMs 208 in the active mode 438 is stored on a first UICC 118 and at least another of the one or more SIMs or eSIMs 208 is stored on a second UICC 118, and the at least one additional SIM or eSIM 208 includes an eSIM 208 stored on an eUICC 108. In some embodiments, the number of standardized input/output ports of the baseband component 110 is two. In some embodiments, transitioning the first SIM or eSIM 208 from the active mode 438 to the standby mode 440 includes: i) latching a second communication interface of a second hardware element storing the first SIM or eSIM 208 to the standby state, and ii) subsequently disconnecting a corresponding standardized input/output port of the baseband component 110 from the second communication interface of the second hardware element storing the first SIM or eSIM 208. In some embodiments, transitioning the second SIM or eSIM 208 from the standby mode 440 to the active mode 438 includes: i) connecting the corresponding standardized input/output port of the baseband component 110 to the communication interface of the hardware element storing the second SIM or eSIM 208, and ii) subsequently releasing the communication interface of the hardware element storing the second SIM or eSIM 208 from the standby state. In some embodiments, the standby state for the communication interface includes:

i) a clock line of the communication interface halted in a clock-stop mode, ii) a data line of the communication interface held to a high voltage value corresponding to a reception mode, iii) a reset line of the communication interface held to a high voltage value, and iv) an input voltage line maintaining power delivery to the communication interface. In some embodiments, transitioning the communication interface to the standby state includes latching multiple lines of the communication interface to an applicable high voltage value provided by a power supply connected to the hardware element via a hardware ISO line switching multiplexer 406. In some embodiments, the first SIM or eSIM 208 transitions from the active mode 438 to the standby mode 440 before the second SIM or eSIM 208 transitions from the standby mode 440 to the active mode 438. In some embodiments, the method further includes: i) enabling one or more eSIMs of the multi-SIM/eSIM wireless device to the active mode 438, and ii) connecting each of the one or more SIMs or eSIMs 208 in the active mode 438 to a corresponding standardized input/output port of a baseband component 110 of the multi-SIM/eSIM wireless device.

### Representative Exemplary Apparatus

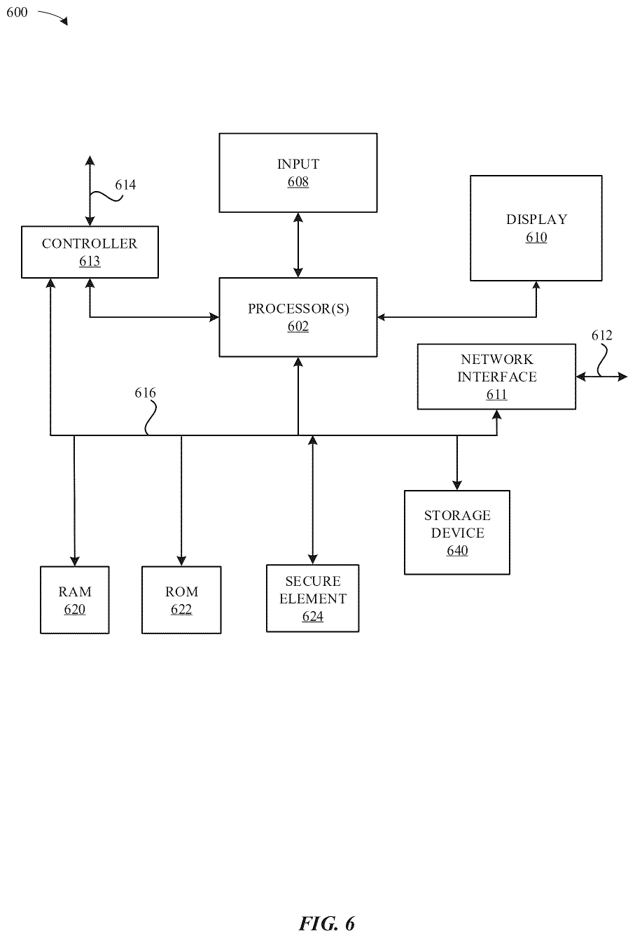

FIG. 6 illustrates in block diagram format an exemplary computing device 600 that can be used to implement the various components and techniques described herein, according to some embodiments. In particular, the detailed view of the exemplary computing device 600 illustrates various components that can be included in the wireless device 102. As shown in FIG. 10, the computing device 600 can include one or more processors 602 that represent microprocessors or controllers for controlling the overall operation of computing device 600. In some embodiments, the computing device 600 can also include a user input device 608 that allows a user of the computing device 600 to interact with the computing device 600. For example, in some embodiments, the user input device 608 can take a variety of forms, such as a button, keypad, dial, touch screen, audio input interface, visual/image capture input interface, input in the form of sensor data, etc. In some embodiments, the computing device 600 can include a display 610 (screen display) that can be controlled by the processor(s) 602 to display information to the user (for example, information relating to incoming, outgoing, or active communication sessions). A data bus 616 can facilitate data transfer between at least a storage device 640, the processor(s) 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include wireless circuitry, such as a wireless transceiver and/or baseband component. The computing device 600 can also include a secure element 624. The secure element 624 can include an eUICC 108, an iUICC, and/or one or more UICCs 118.

The computing device 600 also includes a storage device 640, which can include a single storage or a plurality of storages (e.g., hard drives and/or solid-state drives), and includes a storage management module that manages one or more partitions within the storage device 640. In some embodiments, storage device 640 can include flash memory, semiconductor (solid state) memory or the like. The computing device 600 can also include a Random-Access Memory (RAM) 620 and a Read-Only Memory (ROM) 622. The ROM 622 can store programs, utilities or processes to be executed in a non-volatile manner. The RAM 620 can provide volatile data storage, and stores instructions related to the operation of the computing device 600.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to manage configuration of multiple subscriber identity modules (SIMs) and/or electronic SIMs (eSIMs) of a multi-SIM/eSIM wireless device, the method comprising:
enabling at least one additional SIM or eSIM to a standby mode, wherein for each additional SIM or eSIM of the at least one additional SIM or eSIM:
a radio software stack is maintained and cached by a baseband component; and
a hardware state of a communication interface of a hardware element storing the additional SIM or eSIM is latched to a standby state; and
transitioning a first SIM or eSIM of one or more SIMs or eSIMs from an active mode to the standby mode in conjunction with transitioning a second SIM or eSIM of the at least one additional SIM or eSIM from the standby mode to the active mode,
wherein a number of SIMs or eSIMs in the active mode is limited to not exceed a number of standardized input/output ports of the baseband component usable for communicating with SIMs or eSIMs.

2. The method of claim 1, wherein the standardized input/output ports of the baseband component are communicatively coupled to corresponding communication interfaces of one or more hardware elements storing the one or more SIMs or eSIMs and/or to the hardware element storing the at least one additional SIM or eSIM via a hardware ISO line switching multiplexer.

3. The method of claim 1, wherein:
at least one of the one or more SIMs or eSIMs in the active mode is stored on a first universal integrated circuit card (UICC) and at least another of the one or more SIMs or eSIMs in the active mode is stored on a second UICC; and
the at least one additional SIM or eSIM comprises an eSIM stored on an embedded UICC (eUICC).

4. The method of claim 3, wherein the number of standardized input/output ports of the baseband component is two.

5. The method of claim 1, wherein transitioning the first SIM or eSIM from the active mode to the standby mode comprises:
latching a second communication interface of a second hardware element storing the first SIM or eSIM to the standby state; and
subsequently disconnecting a corresponding standardized input/output port of the baseband component from the second communication interface of the second hardware element storing the first SIM or eSIM.

6. The method of claim 5, wherein transitioning the second SIM or eSIM from the standby mode to the active mode comprises:
connecting the corresponding standardized input/output port of the baseband component to the communication interface of the hardware element storing the second SIM or eSIM; and
subsequently releasing the communication interface of the hardware element storing the second SIM or eSIM from the standby state.

7. The method of claim 1, wherein the standby state for the communication interface comprises:
a clock line of the communication interface halted in a clock-stop mode;
a data line of the communication interface held to a high voltage value corresponding to a reception mode;
a reset line of the communication interface held to a high voltage value; and
an input voltage line maintaining power delivery to the communication interface.

8. The method of claim 1, wherein transitioning the communication interface to the standby state comprises:
latching multiple lines of the communication interface to an applicable high voltage value provided by a power supply connected to the hardware element via a hardware ISO line switching multiplexer.

9. The method of claim 1, wherein the first SIM or eSIM transitions from the active mode to the standby mode before the second SIM or eSIM transitions from the standby mode to the active mode.

10. The method of claim 1, further comprising:
enabling the one or more SIMs or eSIMs to the active mode; and
connecting each of the one or more SIMs or eSIMs in the active mode to a corresponding standardized input/output port of the baseband component of the multi-SIM/eSIM wireless device.

11. One or more processors of a wireless device comprising multiple subscriber identity modules (SIMs) and/or electronic SIMs (eSIMs), the one or more processor configured to:
enable at least one additional SIM or eSIM to a standby mode, wherein for each additional SIM or eSIM of the at least one additional SIM or eSIM:
a radio software stack is maintained and cached by a baseband component; and
a hardware state of a communication interface of a hardware element storing the additional SIM or eSIM is latched to a standby state; and
transition a first SIM or eSIM of one or more SIMs or eSIMs from an active mode to the standby mode in conjunction with transitioning a second SIM or eSIM of the at least one additional SIM or eSIM from the standby mode to the active mode,
wherein a number of SIMs or eSIMs in the active mode is limited to not exceed a number of standardized input/output ports of the baseband component usable for communicating with SIMs or eSIMs.

12. The one or more processors of claim 11, wherein the standardized input/output ports of the baseband component are communicatively coupled to corresponding communication interfaces of one or more hardware elements storing the one or more SIMs or eSIMs and/or to the hardware element storing the additional SIM or eSIM via a hardware ISO line switching multiplexer.

13. The one or more processors of claim 11, wherein:
at least one of the one or more SIMs or eSIMs in the active mode is stored on a first universal integrated circuit card (UICC) and at least another of the one or more SIMs or eSIMs in the active mode is stored on a second UICC; and
the at least one additional SIM or eSIM comprises an eSIM stored on an embedded UICC (eUICC).

14. The one or more processors of claim 13, wherein the number of standardized input/output ports of the baseband component is two.

15. The one or more processors of claim 11, wherein the one or more processors are further configured to transition the first SIM or eSIM from the active mode to the standby mode by:
latching a second communication interface of a second hardware element storing the first SIM or eSIM to the standby state; and
subsequently disconnecting a corresponding standardized input/output port of the baseband component from the second communication interface of the second hardware element storing the first SIM or eSIM.

16. The one or more processors of claim 15, wherein the one or more processors are further configured to transition the second SIM or eSIM from the standby mode to the active mode by:
connecting the corresponding standardized input/output port of the baseband component to the communication interface of the hardware element storing the second SIM or eSIM; and
subsequently releasing the communication interface of the hardware element storing the second SIM or eSIM from the standby state.

17. The one or more processors of claim 11, wherein the standby state for the communication interface comprises:
a clock line of the communication interface halted in a clock-stop mode;
a data line of the communication interface held to a high voltage value corresponding to a reception mode;
a reset line of the communication interface held to a high voltage value; and
an input voltage line maintaining power delivery to the communication interface.

18. The one or more processors of claim 11, wherein transitioning the communication interface to the standby state comprises:
latching multiple lines of the communication interface to an applicable high voltage value provided by a power supply connected to the hardware element via a hardware ISO line switching multiplexer.

19. The one or more processors of claim 11, wherein the one or more processors are further configured to:
enable the one or more SIMs or eSIMs to the active mode; and
connect each of the one or more SIMs or eSIMs in the active mode to a corresponding standardized input/output port of the baseband component of the wireless device.

20. A non-transitory computer-readable medium storing instructions for configuring one or more processors to manage configuration of multiple subscriber identity modules (SIMs) and/or electronic SIMs (eSIMs) of a multi-SIM/eSIM wireless device, the instructions comprising:
instructions for enabling at least one additional SIM or eSIM to a standby mode, wherein for each additional SIM or eSIM of the at least one additional SIM or eSIM:
a radio software stack is maintained and cached by a baseband component; and
a hardware state of a communication interface of a hardware element storing the additional SIM or eSIM is latched to a standby state; and
instructions for transitioning a first SIM or eSIM of one or more SIMs or eSIMs from an active mode to the standby mode in conjunction with transitioning a second SIM or eSIM of the at least one additional SIM or eSIM from the standby mode to the active mode,
wherein a number of SIMs or eSIMs in the active mode is limited to not exceed a number of standardized input/output ports of the baseband component usable for communicating with SIMs or eSIMs.
